(19) United States
(12) Patent Application Publication
(10) Pub. No.: US 2011/0219663 A1
(43) Pub. Date: Sep. 15, 2011

(54) Artificial Weed System for Fishing

(76) Inventor: David J. Nichol, Gainesville, GA (US)

(21) Appl. No.: 13/101,603

(22) Filed: May 5, 2011

(51) Int. Cl. A01K 97/02; A01K 61/00

(52) U.S. Cl. 43/44.99; 119/221

(57) ABSTRACT

An artificial weed system for attracting fish includes a circular hoop and a plurality of spaced apart artificial weed bundles. The circular hoop has a first end and a opposite second end. Each of the plurality of spaced apart artificial weed bundles is affixed to the hoop. Each weed bundle includes a first end that is affixed to the hoop, each of the plurality of artificial weed bundles includes a plurality of strands extending from the first end. Each strand has a specific gravity that is no greater than 1.0 and each strand includes a synthetic filament. A first attachment device is affixed to the first end of the hoop and a second attachment device is affixed to the second end of the hoop.

### BACKGROUND OF THE INVENTION

1. Field of the Invention

The present invention relates to fishing tackle and, more specifically, to an artificial weed system for attracting fish.

2. Description of the Related Art

Fishing is a popular activity throughout the world. Avid anglers frequently seek to fish in areas having weed growth because fish are frequently found in such areas. Typically, small bait fish go into the weeds to hide from larger game fish. The game fish are attracted to such areas because they are more likely to find the bait fish there.

Many artificial lakes and lakes in rocky environments lack large scale weed growth. To compensate for this, anglers will sometimes cut branches off of trees, add weights to them and place them into the water to create an artificial environment to attract fish. This practice results in damage to the trees at the shoreline and the results are temporary since the tree branches tend to decay over time. It is also time consuming for the angler.

In the context of ocean fishing, many littoral areas with sandy bottoms lack substantial weed growth. Also, in the context of deep sea fishing, there tend not to be any weeds at the depths where desired game fish inhabit.

Therefore, there is a need for portable system for introducing artificial weeds to a body of water to attract fish.

### SUMMARY OF THE INVENTION

The disadvantages of the prior art are overcome by the present invention which, in one aspect, is an artificial weed system for attracting fish that includes a circular hoop and a plurality of spaced apart artificial weed bundles. The circular hoop has a first end and a opposite second end. Each of the plurality of spaced apart artificial weed bundles is affixed to the hoop. Each weed bundle includes a first end that is affixed to the hoop, each of the plurality of artificial weed bundles includes a plurality of strands extending from the first end. Each strand has a specific gravity that is no greater than 1.0 and each strand includes a synthetic filament. A first attachment device is affixed to the first end of the hoop and a second attachment device is affixed to the second end of the hoop.

In another aspect, the invention is a synthetic weed system that includes a frame, at least one artificial weed bundle, a float and an anchor. The frame has a first end and a opposite second end. The at least one artificial weed bundle has a first end affixed to the frame and a plurality of strands extending from the first end. Each of the plurality of strands has a specific gravity that is no greater than 1.0 and includes a synthetic artificial turf filament. The float is coupled to the first end of the frame. The anchor is coupled to the second end of the frame.

In yet another aspect, the invention is an artificial fish cover system in which at least one first frame is disposed in a body of water at a depth corresponding to a habitat zone. Each of a plurality of bundles of synthetic grass blade strands is spaced apart and attached to the first frame at a first end. A float, a portion of which is disposed in the body of water, is coupled to the first frame so as to suspend the frame in an upright position. A weight is coupled to the first frame and is disposed in the body of water.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a plan view of one representative embodiment of an artificial weed system.

FIG. 2 is an elevational view of one embodiment of an artificial weed system in use.

FIG. 3 is an elevational view of a multi-unit artificial weed system.

FIG. 4 is an elevational view of a spiral embodiment multi-unit artificial weed system.

FIG. 5 is an elevational view of a linear embodiment multi-unit artificial weed system.

FIG. 6A is a detail of an artificial weed system with an integrated chum holder.

FIG. 6B is a detail of an artificial weed system with a separate chum holder.

FIG. 6C is a detail of an artificial weed system showing an alternate method of affixing artificial weed bundles to the frame.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

U.S. Pat. No. 3,332,828, issued to Faria et al., discloses a monofilament ribbon pile product used in artificial turf applications and is incorporated herein by reference for the purpose of disclosing grass-like filaments.

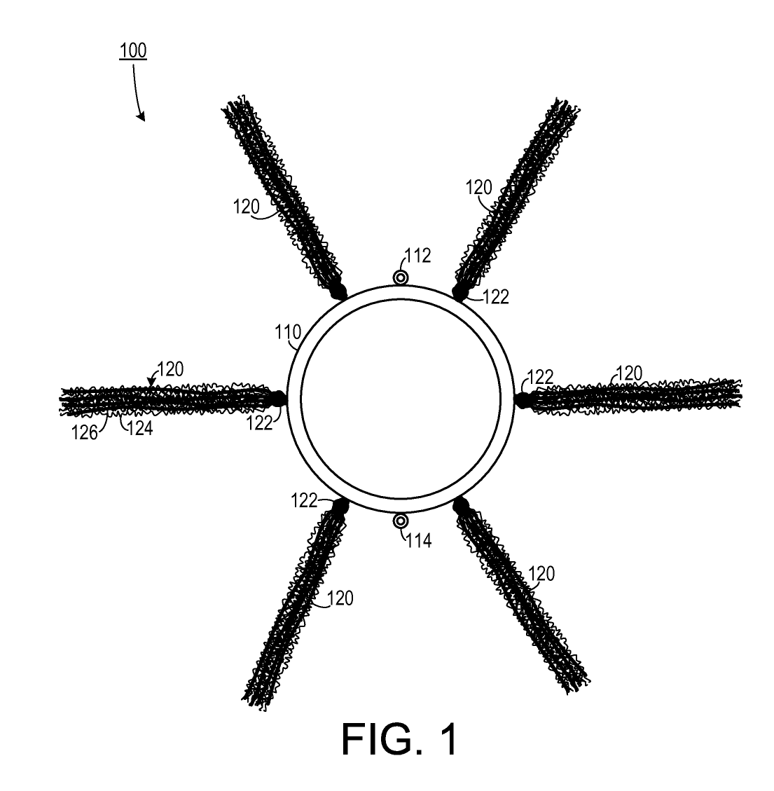

As shown in FIG. 1, one embodiment of an artificial weed unit 100 includes a frame 110, which could be a circular hoop or a structure having one of many other shapes, to which a plurality of spaced apart artificial weed bundles 120 is affixed. In one embodiment, the frame 110 includes a circular hoop made from a polyvinyl chloride (PVC) tube (in other embodiments, it could include any material capable of resisting corrosion while being immersed in water, such as a fiberglass rod). Each weed bundle 120 includes a first end 122 that is affixed to the frame 110.

Each weed bundle 120 includes plurality of synthetic filament strands (which in one embodiment can include fine crinkled strands 124 and grass blade shaped strands 126, other shapes of strands could also be employed to simulate other weed configurations) that extend from the first end 122. In one embodiment, the strands have a color (such as green or brown) that corresponds to the color of natural weeds found in the body of water in which the device is intended to be used. In one embodiment, the strands 124 and 126 have a specific gravity that is no greater than 1.0 so that when the bundle 120 is placed in a body of water, the strands 124 and 126 either tend to float or are neutrally buoyant so as to appear like natural weeds or algae. In one embodiment, the strands could have a specific gravity of greater than 1.0 where it is desirable for the strands to hang down from the frame, such as in certain deep sea fishing applications. In one embodiment, the plurality of strands includes an extruded monofilament material including a polymer such as: a nylon; a polyester, a polypropylene and copolymers thereof. The strands can be made from the type of fiber generally employed in artificial turf surfaces.

A first attachment device 112 may be affixed to a first end of the frame 110 and a second attachment device 114 may be affixed to a second end of the hoop 110. These attachment devices 112 and 114 could include ring-shaped structures that are integrated with the frame 110, loose rings that encircle a portion of the frame 110, a plastic connector (such as a cable clamp or a nylon cable tie or a piece) that encircles a portion of the frame, or even a short piece of flexible line or non-corrosive wire that is tied or wrapped about a portion of the frame. The attachment devices 112 and 114 can be used for attaching floats, weights, retrieval lines and other frames to the frame 110.

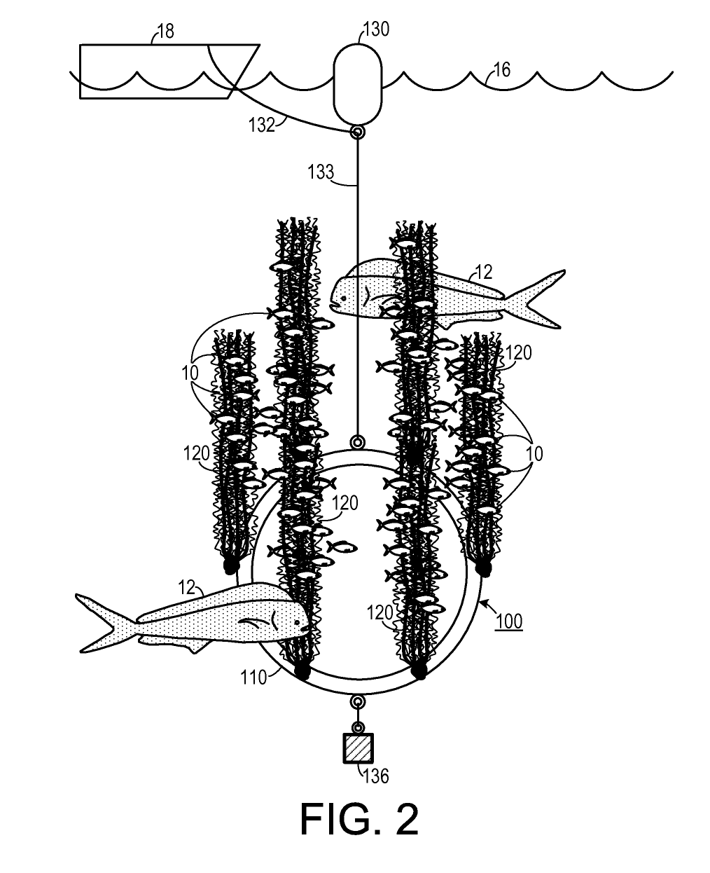

As shown in FIG. 2, in an embodiment that would typically be used in a deep sea fishing application, a float 130 is attached to a top portion of the frame 110 with a line 133 of sufficient length so that the frame 110 is suspended at a depth where fish are thought to inhabit while the float 130 floats at the surface 16 of the body of water. A retrieval line 132 can be attached either to the float 130 or the frame 110 to keep the device within a desired distance of a fishing boat 18. In this embodiment, a weight 136 is either suspended from the bottom of the frame 110 or integrated into the frame 110 to maintain the frame 110 at the desired depth. This embodiment provides what appears to be a growth of weeds that attracts small bait fish 10, which attract sport fish 12.

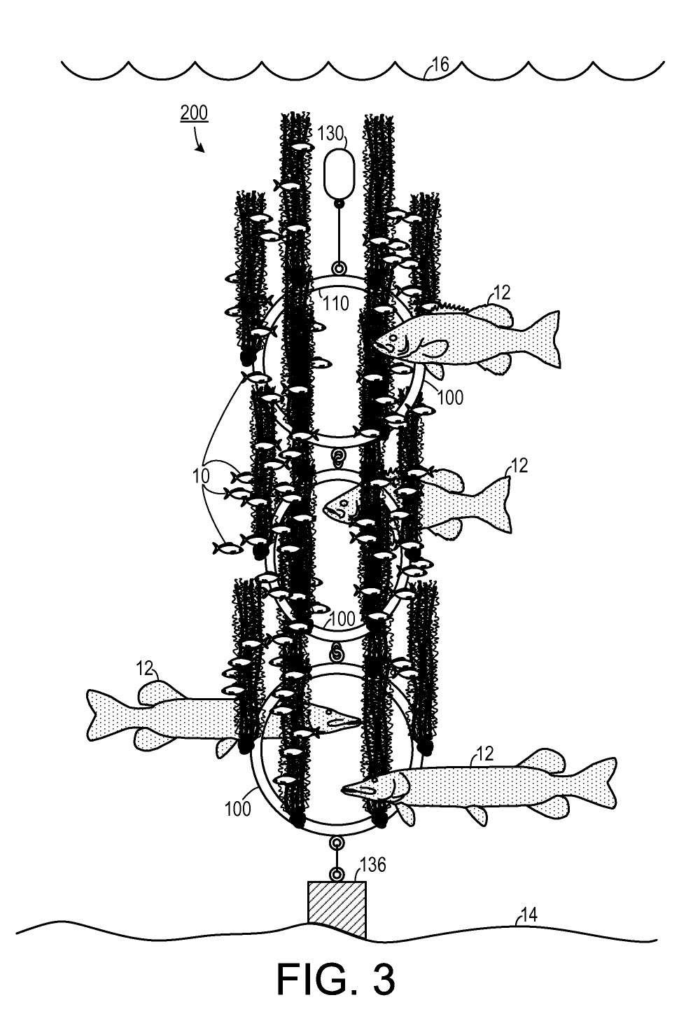

As shown in FIG. 3, several artificial weed units 100 can be interconnected to create a larger artificial weed structure 200. Many configurations of artificial weed units 100 are possible, including vertical chains of weed units 100, horizontal chains, diagonal chains and combinations thereof The embodiment shown would be typical for use in a relatively shallow lake, where the weight 136 anchors the structure 200 to the bottom 14 of the lake and the float 130 (which could be integrated in one or more of the frames 110) holds the structure 200 in an upright position. In this embodiment, the float 130 is kept under the surface of the water 16 to preserve the secrecy of where the artificial weed structure 200 has been placed. In certain embodiments, keeping the frame 110 and the weed bundles 120 above the bottom surface 14 is important because if the weed bundles 120 are kept at the bottom surface 14, they can begin to silt up, which will cause them to lay down and become ineffective.

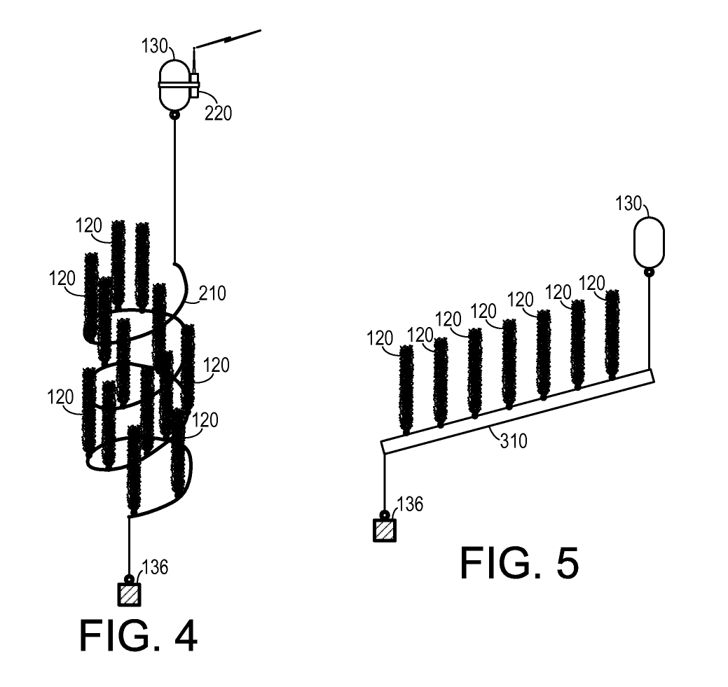

It will be understood that the frame can have one of many shapes. For example, a collapsible spiral frame 210 is shown in FIG. 4. In this embodiment, the frame could include flexible tubing that is pre-stressed so as to collapse into a spiral member when external forces (such as from a float 130 and an anchor weight 136) are not applied to the ends of the frame 210. This embodiment also shows a locating signal transponder 220 that is integrated with the float 130 (which could alternately be affixed to the frame 210). The transponder 220 could be used to locate the device. Another configuration for the frame 310 is shown in FIG. 5, in which the frame 310 is simply a liner PVC tube to which the weed bundles 120 are attached. This embodiment is easy to construct and takes little storage space. It will be appreciated that many other frame shapes (e.g., rectangular, triangular, spherical, conical, etc.) and materials may be employed without departing from the scope of the invention.

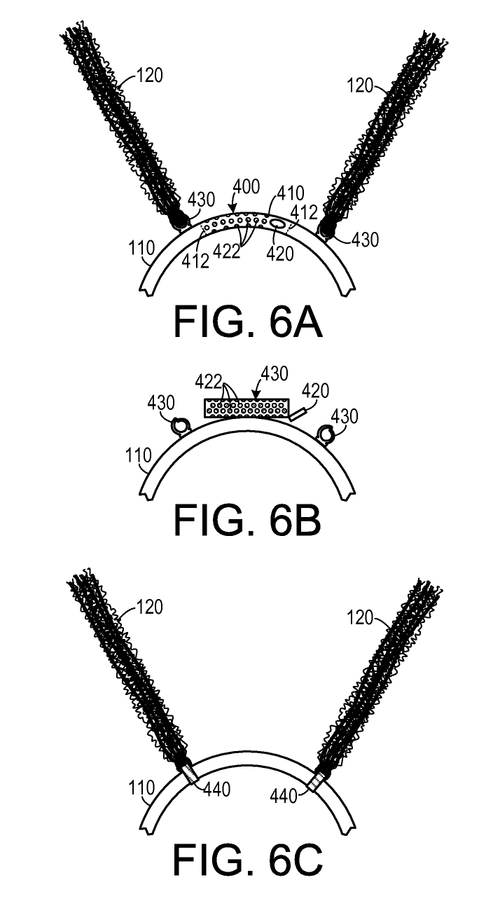

As shown in FIG. 6A, a chum holder 400 can be integrated into the frame 110. The chum holder 400 can include a tubular portion 410 that is separated from the frame by a pair of internal walls 412 so as to create a cavity configured to hold chum therein. A door 420 allows for placement of chum into the cavity when the door is open. A plurality of holes 422 that open into the cavity allows for liquids and small particles to drift out of the cavity into the water, thereby further attracting fish. FIG. 6A also shows one embodiment of attaching the weed bundles 120 to the frame 110, in which releasable electrical cable clamps 430 are affixed to the frame 110. These clamps 430 allow the user to disconnect the weed bundles 120 from the frame 110 to facilitate storage and cleaning These clamps 430 are shown in FIG. 6B without weed bundles attached thereto. Also shown in FIG. 6B is a configuration wherein a separate chum tube 430 is coupled to the frame 110. This configuration can allow the chum tube 430 to be cleaned and stored separately from the frame 110.

An alternate method of attaching the weed bundles 120 to the frame 110 is shown in FIG. 6C, in which a piece of heat shrink tubing 440 is placed about a portion of the frame 110 and the strands of the weed bundles 120 are fed through the heat shrink tubing 440. The heat shrink tubing 440 is then heated so as to cause it to shrink, thereby affixing the strands to the frame 110.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. An artificial weed system for attracting fish, comprising:
(a) a circular hoop having a first end and a opposite second end;
(b) a plurality of spaced apart artificial weed bundles affixed to the hoop, each weed bundle including a first end that is affixed to the hoop, each of the plurality of artificial weed bundles including a plurality of strands extending from the first end, each strand having a specific gravity that is no greater than 1.0 and each strand comprising a synthetic filament;
(c) a first attachment device affixed to the first end of the hoop; and
(d) a second attachment device affixed to the second end of the hoop.

2. The artificial weed system of claim 1, further comprising:
(a) a float coupled to the first attachment device; and
(b) an anchor coupled to the second attachment device.

3. The artificial weed system of claim 1, wherein the circular hoop comprises a polyvinyl chloride tube.

4. The artificial weed system of claim 1, wherein the plurality of strands comprises a extruded monofilament material selected from a group consisting of: nylons; polyesters, polypropylenes and copolymers thereof

5. The artificial weed system of claim 1, wherein each of the plurality of strands has a color corresponding to a natural grass found in a body of water.

6. The artificial weed system of claim 1, wherein the plurality of strands comprises:
(a) a plurality of fine crinkled strands; and
(b) a plurality of straight grass blade shaped strands.

7. The artificial weed system of claim 1, further comprising a chum holder affixed to the hoop, the chum holder comprising:
(a) a tubular portion having an interior cavity and defining a plurality of holes opening into the interior cavity; and
(b) a door formed in the tubular portion and configured to allow placement of chum into the cavity when the door is open.

8. The artificial weed system of claim 1, further comprising a plurality of releasable attachment clips attached to the hoop and configured to releasably attach one of the artificial weed bundles to the frame.

9. The artificial weed system of claim 1, further comprising a heat-shrink tube encircling a portion of the hoop and a portion of at least one of the artificial weed bundles, thereby affixing the at least one artificial weed bundle to the hoop.

10. The artificial weed system of claim 1, further comprising a locating transponder coupled to the hoop.

11. A synthetic weed system, comprising:
(a) a frame having a first end and a opposite second end;
(b) at least one artificial weed bundle having a first end affixed to the frame and a plurality of strands extending from the first end, each of the plurality of strands having a specific gravity that is no greater than 1.0 and comprising a synthetic artificial turf filament;
(c) a float coupled to the first end of the frame; and
(d) an anchor coupled to the second end of the frame.

12. The synthetic weed system of claim 11, wherein the frame comprises a circular hoop and wherein each of a plurality of artificial weed bundles is coupled to the circular hoop at spaced-apart locations.

13. The synthetic weed system of claim 12, wherein the circular hoop comprises a polyvinyl chloride tube.

14. The synthetic weed system of claim 11, wherein the frame comprises a collapsible spiral member and wherein each of a plurality of artificial weed bundles is coupled to the spiral member at spaced-apart locations.

15. The synthetic weed system of claim 11, wherein each of the plurality of strands comprises an extruded monofilament.

16. The synthetic weed system of claim 15, wherein the plurality of strands comprises a material selected from a group consisting of: nylons; polyesters, polypropylenes and copolymers thereof.

17. The synthetic weed system of claim 11, wherein the plurality of strands comprises:
(a) a plurality of fine crinkled strands; and
(b) a plurality of straight grass blade shaped strands.

18. The synthetic weed system of claim 11, further comprising a releasable attachment clip attached to the frame and configured to releasably attach the artificial weed bundle to the frame.

19. An artificial fish cover system, comprising:
(a) at least one first frame disposed in a body of water at a depth corresponding to a habitat zone;
(b) a plurality of bundles of synthetic grass blade strands spaced apart and attached to the first frame at a first end;
(c) a float, a portion of which is disposed in the body of water, coupled to the first frame so as to suspend the frame in an upright position; and
(d) a weight coupled to the first frame and disposed in the body of water so a to maintain the first frame at a predetermined depth.

20. The artificial weed system of claim 19, at least one second frame with a plurality of bundles of synthetic grass blade strands attached thereto, the second frame coupled to the first frame and to the anchor.
